(19) United States
(12) Patent Application Publication
(10) Pub. No.: US 2020/0157783 A1
(43) Pub. Date: May 21, 2020

(54) Wind-driven Air-Compressed Energy-Saving Collecting and Filtering Device for Field Fresh water

(71) Applicant: Chun Ho YAU, Hong Kong (HK)

(72) Inventor: Chun Ho YAU, Hong Kong (HK)

(21) Appl. No.: 16/239,503

(22) Filed: Jan. 3, 2019

(30) Foreign Application Priority Data
Nov. 19, 2018 (CN) 201811379303.1

(51) Int. Cl. E03B 3/28; C02F 1/32; B01D 5/00

(52) U.S. Cl. CPC E03B 3/28; C02F 1/32; B01D 5/009; B01D 5/0039; B01D 5/0072

(57) ABSTRACT

The invention relates to a wind-driven air-compressed energy-saving collecting and filtering device for field fresh water which includes a water collecting tank, a cooling pipe, a compression pipe and a wind wheel. The water collecting tank is provided with a pressure relief pipe, an outlet pipe and a plug. The outer side of the cooling pipe is provided with an ultraviolet sterilizer. The inner cavity of the cooling pipe is provided with a fin condenser. The upper end of the compression pipe is connected to an end cover, a second annular housing, a power generating coil disposed in the inner cavity of the second annular housing. The end cover is provided with a commutator. The inner cavity of the compression pipe is provided with a first rotating shaft, magnetic compression blades, and a limiting mesh plate. The wind wheel includes a bracket and Y-shaped blades. The wind-driven air-compressed energy-saving collecting and filtering device for field fresh water of the present invention has reasonable and simple structure, convenient to use, low cost, convenient to install, energy saving and environment friendly which effectively solve the problem of lack of fresh water in specific areas such as deserts and islands.

### FIELD OF THE INVENTION

The invention relates to freshwater collecting and filtering equipment, in particular to a wind-driven air-compressed energy-saving collecting and filtering device for field fresh water.

### BACKGROUND

Although water is a renewable resource, due to the large demand, industrial pollution, and uneven distribution of fresh water resources, etc., if it is necessary to use water in areas such as deserts and islands that are 15 particularly lacking in fresh water, it is generally through deep wells, seawater desalination or water storage to transport fresh water. However, whether it is drilling wells, desalination or using fresh water storage devices to transport fresh water requires the support of large equipment, and the energy supply of large equipment will become a new problem. For drilling wells, it is difficult to determine the well location. The use of water storage devices to transport fresh water is prone to danger along the way, and the use of existing desalination technology is too costly. Therefore, it is necessary to develop a fresh water collecting device that is simple to use, low in cost, and easy to install.

### SUMMARY OF THE INVENTION

The technical problem to be solved is to overcome the above-mentioned deficiency by providing a wind-driven air-compressed energy-saving collecting and filtering device for field fresh water with reasonable and simple structure, convenient to use, low cost, convenient to install, energy saving and environment friendly which effectively solve the problem of lack of fresh water in specific areas such as deserts and islands.

The technical solution of the present invention is to provide a wind-driven air-compressed energy-saving collecting and filtering device for field fresh water which includes a water collecting tank, a cooling pipe, a compression pipe and a wind wheel. The water collecting tank and the cooling pipe are arranged under the ground surface, and the compression pipe and the wind wheel are arranged on the ground surface. The water collecting tank is provided with a pressure relief pipe communicated with the ground surface and the inner cavity of the water collecting tank. An outlet pipe is provided in the inner cavity of the pressure relief pipe, and a plug is arranged on the port at one end of the pressure relief pipe located at the ground surface.

The cooling pipe is a transparent pipe body vertically disposed above the water collecting tank. The lower end of the cooling pipe and the water collecting tank are fixed to each other, and the inner cavity of the cooling pipe communicates with the inner cavity of the water collecting tank. The outer side of the cooling pipe is provided with an ultraviolet sterilizer, and the inner cavity of the cooling pipe is provided with a fin condenser.

The ultraviolet sterilizer includes a first annular housing. The inner cavity of the first annular housing is provided with a battery. An ultraviolet disinfecting lamp is disposed adjacent to the outer wall of the cooling pipe in the inner cavity of the first annular housing.

The fin condenser includes a vertically disposed support shaft and fins radially fixedly disposed on the support shaft. The support shaft is fixedly connected to the inner wall of the cooling pipe. The fins abuts against the inner wall of the cooling pipe.

The compression pipe is disposed above the cooling pipe, and the lower end of the compression pipe is sleeved and fixedly connected to the upper end of the cooling pipe. The compression pipe has a tapered inner cavity, and the upper end of the compression pipe is threadedly connected to an end cover made of a mesh plate, a second annular housing, and a power generating coil disposed in the inner cavity of the second annular housing.

The end cover is provided with a commutator. The inner cavity of the compression pipe is provided with a first rotating shaft, magnetic compression blades fixedly connected to the first rotating shaft, and a limiting mesh plate.

Two ends of the first rotating shaft are respectively connected to the commutator and the limiting mesh plate.

The commutator includes a housing, a first ratchet, a plurality of transmission gears, and a second ratchet. The first rotating shaft and the second rotating shaft protrude symmetrically into the inner cavity of the housing. The first ratchet and the second ratchet are drivingly connected to the second rotating shaft by the transmission gears. The first ratchet is drivingly connected to the first rotating shaft by the third rotating shaft and the transmission gears. The second ratchet is connected to the first rotating shaft sequentially through the transmission gears and the fourth rotating shaft.

The first ratchet and the second ratchet respectively include a disc, a magnetic ratchet hinged along the circumference of the disc, and a receiving groove for receiving the ratchet.

The wind wheel includes a bracket fixedly connected to the second rotating shaft and Y-shaped blades disposed on the bracket.

Further, the outer surface of the water collecting tank is provided with a plurality of heat conducting plates, and the heat conducting plates are provided with a plurality of heat conducting rods.

Further, the fin in a spiral shape is fixedly connected to the support shaft, and a plurality of through holes are arranged on the fin.

Further, the outer surface of the end cover is provided with a filter net.

Further, the upper end of the compression pipe is provided with a sunshade mechanism, and the sunshade mechanism includes a support rod connected to the outer wall of the compression pipe by a magnetic ball joint. The support rod is provided with an elastic shade cloth.

Further, the lower end of the compression pipe is provided with a stabilizing plate for preventing the compression pipe and the wind wheel from tipping over, and the middle portion of the stabilizing plate is sleeved and fixed with the compression pipe.

Further, the disc is made of a non-magnetizable material. The magnetic ratchet abuts against the inner wall of the receiving groove when the magnetic ratchet is deployed. When the magnetic ratchet needs to be taken away, it contracts and is accommodated into the receiving groove.

Further, the power generating coil is electrically connected to the battery.

Further, the bracket includes two support plates and a connecting shaft for connecting the two support plates. The Y-shaped blades are radially fixed on the connecting shaft.

The technical effect of the present invention is to provide a wind-driven air-compressed energy-saving collecting and filtering device for field fresh water which includes a water collecting tank, a cooling pipe, a compression pipe and a wind wheel which are arranged sequentially from bottom to top. The water collecting tank and the cooling pipe are arranged under the ground surface. The compression pipe and the wind wheel are arranged on the ground surface. The wind wheel can convert the wind energy in different directions into power to rotate the magnetic compression blades in the compression pipe. The air with moisture is compressed into the cooling pipe and condensed to liquid water by utilizing the temperature difference between the ground surface and the underground. The liquid water is stored in the water collecting tank. The air whose moisture has been removed is discharged through the pressure relief pipe on the water collecting tank. An air output of the pressure relief pipe is blocked by the plug so that the pressure in the water collecting tank rises. The water in the water collecting tank is lifted to the ground surface by the outlet pipe for people's use. The rotation of the magnetic compression blades make the power generating coil to generate electric energy which is supplied to the ultraviolet disinfecting lamp for disinfecting the condensed water. The wind-driven air-compressed energy-saving collecting and filtering device for field fresh water has reasonable and simple structure, convenient to use, low cost, convenient to install, energy saving and environment friendly which effectively solve the problem of lack of fresh water in specific areas such as deserts and islands.

### BRIEF DESCRIPTION OF THE DRAWINGS

The invention is illustrated by the following figures and embodiments.

FIG. 1 shows a schematic diagram of whole structure of a wind-driven air-compressed energy-saving collecting and filtering device for field fresh water in accordance with an example embodiment of the invention.

FIG. 2 shows a schematic diagram of a cross-section of a water collecting tank of a wind-driven air-compressed energy-saving collecting and filtering device for field fresh water in accordance with an example embodiment of the invention.

FIG. 3 shows a schematic diagram of a cooling pipe of a wind-driven air-compressed energy-saving collecting and filtering device for field fresh water in accordance with an example embodiment of the invention.

FIG. 4 shows a schematic diagram of a fin condenser of a wind-driven air-compressed energy-saving collecting and filtering device for field fresh water in accordance with an example embodiment of the invention.

FIG. 5 shows a schematic diagram of a compression pipe of a wind-driven air-compressed energy-saving collecting and filtering device for field fresh water in accordance with an example embodiment of the invention.

FIG. 6 shows a schematic diagram of a commutator of a wind-driven air-compressed energy-saving collecting and filtering device for field fresh water in accordance with an example embodiment of the invention.

FIG. 7 shows a schematic diagram of a second ratchet of a wind-driven air-compressed energy-saving collecting and filtering device for field fresh water in accordance with an example embodiment of the invention.

FIG. 8 shows a schematic diagram of top view of a wind wheel whose support plate on the top is removed of a wind-driven air-compressed energy-saving collecting and filtering device for field fresh water in accordance with an example embodiment of the invention.

The reference numbers of the figures are as follows:
1: water collecting tank; 11: pressure relief pipe; 12: outlet pipe; 13: heat conducting plate; 14: heat conducting rod; 15: plug; 2: cooling pipe; 21: ultraviolet sterilizer; 211: first annular housing; 212: battery; 213: ultraviolet disinfecting lamp; 22: fin condenser; 221: support shaft; 222: fin; 4: compression pipe; 40: limiting mesh plate; 41: second annular housing; 411: power generating coil; 42: sunshade mechanism; 421: support rod 422: shade cloth; 43: stabilizing plate; 44: magnetic compression blade; 45: end cover; 46: filter net; 47: commutator; 471: housing; 472: first ratchet; 473: transmission gear; 474: second ratchet; 4741: disc; 4742: receiving groove; 4743: magnetic ratchet; 477: fourth rotating shaft; 478: third rotating shaft; 48: second rotating shaft; 49: first rotating shaft; 5: wind wheel; 51: bracket; 511: support plate; 512: connecting shaft; 52: Y-shaped blade.

### DETAILED DESCRIPTION

The invention is illustrated in accordance with figures. The figures as simplified diagrams demonstrate the basic structures of the apparatus of embodiments of the invention. Thus, the invention is not limited to the figures.

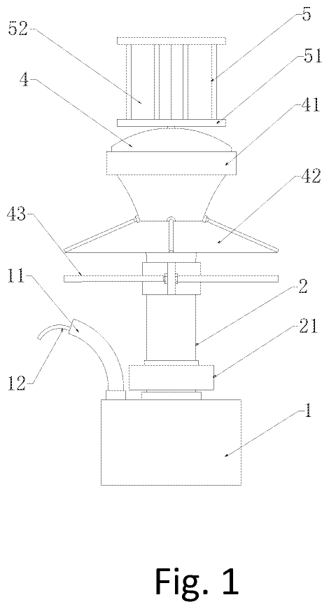

As shown in FIG. 1, a wind-driven air-compressed energy-saving collecting and filtering device for field fresh water includes a water collecting tank 1, a cooling pipe 2, a compression pipe 4 and a wind wheel 5. The water collecting tank 1 and the cooling pipe 2 are arranged under the ground surface, and the compression pipe 4 and the wind wheel 5 are arranged on the ground surface.

The temperature in the water collecting tank 1 and the cooling pipe 2 is decreased by utilizing the lower temperature under the ground.

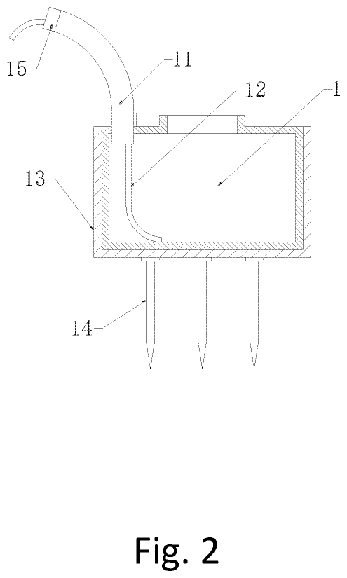

As shown in FIG. 2, the upper end surface of the water collecting tank 1 is provided with a pressure relief pipe 11 communicated with the ground surface and the inner cavity of the water collecting tank 1. An outlet pipe 12 is provided in the inner cavity of the pressure relief pipe 11, and a plug 15 is arranged on the port at one end of the pressure relief pipe 11 located at the ground surface. The other end of the pressure relief pipe 11 is aligned to the top of the inner cavity of the water collecting tank 1. The outlet pipe 12 protrudes into one end of the inner cavity of the water collecting tank 1 and is aligned to the bottom of the inner cavity of the water collecting tank 1. The plug 15 should be made of elastic material. The plug 15 can be removed from the pressure relief pipe 11 and also can block the pressure relief pipe 11.

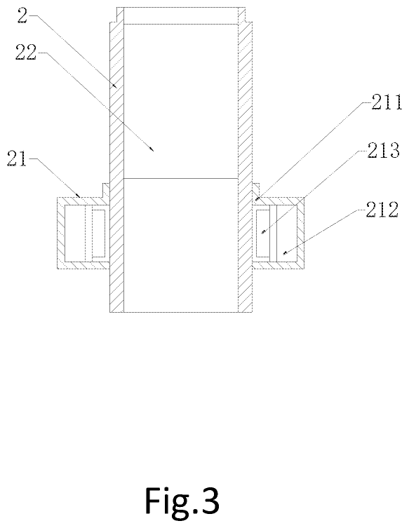

As shown in FIG. 3, the cooling pipe 2 is a transparent pipe body vertically disposed above the water collecting tank 1. The lower end of the cooling pipe 2 and the water collecting tank 1 are fixed to each other, and the inner cavity of the cooling pipe 2 communicates with the inner cavity of the water collecting tank 1. The outer side of the cooling pipe 2 is provided with an ultraviolet sterilizer 21, and the inner cavity of the cooling pipe 2 is provided with a fin condenser 22 for condensing the water in the air.

The ultraviolet sterilizer 21 includes a first annular housing 211. The first annular housing 211 is formed by interconnecting a plurality of curved plates with grooves. The inner cavity of the first annular housing 211 is provided with a battery 212 with a charging and discharging circuit. An ultraviolet disinfecting lamp 213 is disposed adjacent to the outer wall of the cooling pipe 2 in the inner cavity of the first annular housing 211. The ultraviolet light generated by the ultraviolet disinfecting lamp 213 penetrates into the inner cavity of the cooling pipe 2 to kill harmful substances in the water.

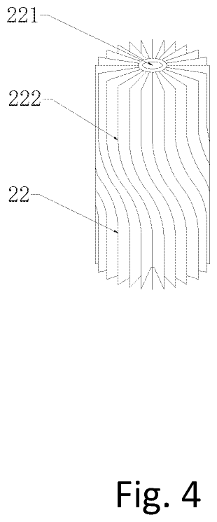

As shown in FIG. 4, the fin condenser 22 includes a vertically disposed support shaft 221 and fins 222 radially fixedly disposed on the support shaft. The support shaft 221 is fixedly connected to the inner wall of the cooling pipe 2. The fins 222 abuts against the inner wall of the cooling pipe 2 to exchange heat with the outer soil with lower temperature through the cooling pipe 2. The temperature of the fins 222 is reduced so that the water in the air passing through the fins 222 is condensed and finally converged into and stored in the water collecting tank 1 under gravity.

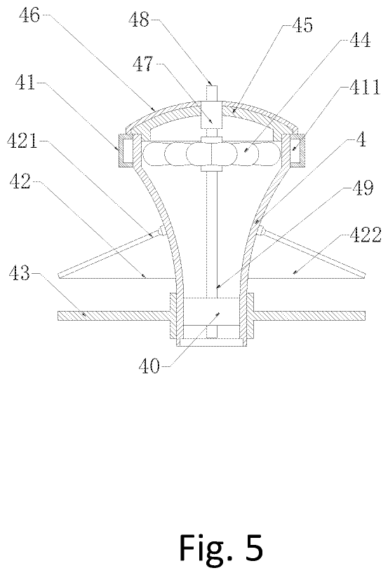

As shown in FIG. 5, the compression pipe 4 is disposed above the cooling pipe 2, and the lower end of the compression pipe 4 is sleeved and fixedly connected to the upper end of the cooling pipe 2. The compression pipe 4 has a tapered inner cavity, and the upper end of the compression pipe 4 is threadedly connected to an end cover 45 made of a mesh plate, a second annular housing 41, and a power generating coil 411 disposed in the inner cavity of the second annular housing 41.

The end cover 45 is provided with a commutator 47. The inner cavity of the compression pipe 4 is provided with a first rotating shaft 49, magnetic compression blades 44 fixedly connected to the first rotating shaft 49, and a limiting mesh plate 40. The middle portion of the limiting mesh plate 40 is provided with a bearing. Two ends of the first rotating shaft 49 are respectively connected to the commutator 47 and the bear of the limiting mesh plate 40.

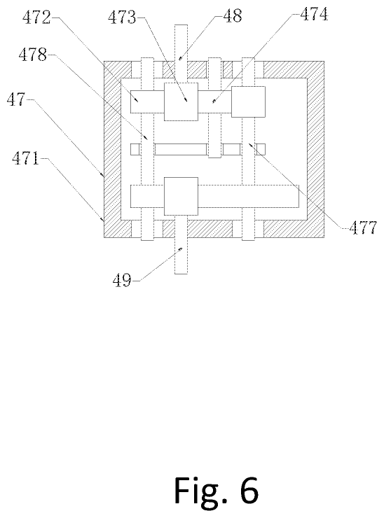

As shown in FIG. 6, the commutator 47 includes a housing 471, a first ratchet 472, a plurality of transmission gears 473, and a second ratchet 474. The first rotating shaft 49 and the second rotating shaft 48 protrude symmetrically into the inner cavity of the housing 471. The first ratchet 472 and the second ratchet 474 are drivingly connected to the second rotating shaft 48 by the transmission gears 473. The first ratchet 472 is drivingly connected to the first rotating shaft 49 by the third rotating shaft 478 and the transmission gears 473. The second ratchet 474 is connected to the first rotating shaft 473 sequentially through the transmission gears 49 and the fourth rotating shaft 477.

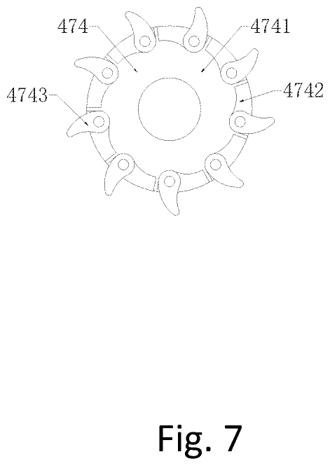

As shown in FIG. 7, the first ratchet 472 and the second ratchet 474 respectively include a disc 4741, a magnetic ratchet 4743 hinged along the circumference of the disc 4741, and a receiving groove 4742 for receiving the ratchet 4743. The disk 4741 should be made of a non-magnetizable material, and the transmission gears 473 that are drivingly connected to the first ratchet 472 and the second ratchet 474 are made of a magnetized material.

Therefore, the second rotating shaft 48 is always in the same direction at the incoming rotational power, and the magnetic compression blades 44 can rotate the compressed air in the same rotational direction.

When the plug 15 is opened, the air from which the moisture is removed in the water collecting tank 1 is discharged by the pressure relief pipe 11. When the plug 15 is blocked, the pressure in the water collecting tank 1 rises under the action of the magnetic compression blades 44, so that the water in the water collecting tank 1 is pressed out of the ground's surface for people's use.

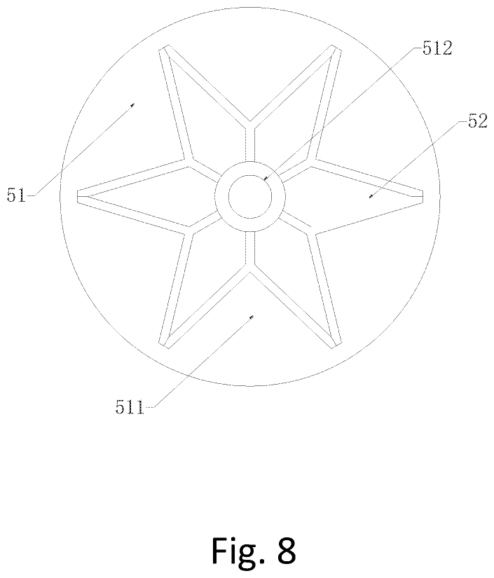

As shown in FIG. 8, the wind wheel 5 includes a bracket 51 fixedly connected to the second rotating shaft 48 and Y-shaped blades 52 disposed on the bracket 51. The Y-shaped blades 52 can receive the power provided by the wind in different directions compared with the traditional blades. The rotation generated by the forward and reverse rotation of the wind weel 5 is converted into the energy rotated in the same direction by the commutator 47. The energy drives the magnetic compression blades 44 to compress the air into the cooling pipe 2.

In one example embodiment, the outer surface of the water collecting tank 1 is provided with a plurality of heat conducting plates 13, and the heat conducting plates 13 are provided with a plurality of heat conducting rods 14. The heat conducting plates 13 and the heat conducting rods 14 accelerate the cooling rate of the water collecting tank 1 to make the condensation effect better.

In one example embodiment, the fin 222 in a spiral shape is fixedly connected to the support shaft 221, and a plurality of through holes are arranged on the fin 222. The through holes are fixed in a spiral shape, and the through holes are provided to increase the contact area between the water vapor and the fin 222.

In one example embodiment, the outer surface of the end cover 45 is provided with a filter net 46. The filter net 46 can also be disposed on the inner side or both the inner and outer sides of the end cover 45. The filter net 46 can be a single layer or a plurality of multi-layer filter net composites.

In one example embodiment, the upper end of the compression pipe 4 is provided with a sunshade mechanism 42, and the sunshade mechanism 42 includes a support rod 421 connected to the outer wall of the compression pipe 4 by a magnetic ball joint. The support rod 421 is provided with an elastic shade cloth 422. Therefore, the support rod 421 with the magnetic ball joint can conveniently drives the shade cloth 422 to adjust its position and also is convenient to be folded and stored.

In one example embodiment, the lower end of the compression pipe 4 is provided with a stabilizing plate 43 for preventing the compression pipe 4 and the wind wheel 5 from tipping over. The middle portion of the stabilizing plate 43 is provided with a through hole which is sleeved and fixed with the compression pipe 4.

The disc 4741 is made of a non-magnetizable material. The magnetic ratchet 4743 abuts against the inner wall of the receiving groove 4742 when the magnetic ratchet 4743 is deployed. When the magnetic ratchet 4743 needs to be taken away, it contracts and is accommodated into the receiving groove 4742. In other words, the magnetic ratchet 4743 can only be deployed in one direction and abuts against the inner wall of the receiving groove 4742. The transmission gears 473 are made of a magnetized material. When the direction of rotation of the transmission gear 473 is opposite to the direction in which the magnetic ratchet 4743 on the first ratchet 472 and the second ratchet 474 is deployed, the magnetic ratchet 4743 on the first ratchet 472 or the second ratchet 474 is engaged with the transmission gear 473 under the magnetic force and vice versa.

The power generating coil 411 is electrically connected to the battery 212. The electric energy generated on the power generating coil 411 by the rotation of the magnetic compression blades 44 is processed by the charging and discharging circuit and stored in the battery 212.

The bracket 51 includes two support plates 511 and a connecting shaft 512 for connecting the two support plates 511. The Y-shaped blades 52 are radially fixed on the connecting shaft 512.

The wind-driven air-compressed energy-saving collecting and filtering device for field fresh water of the present invention includes a water collecting tank, a cooling pipe, a compression pipe and a wind wheel which are arranged sequentially from bottom to top. The water collecting tank and the cooling pipe are arranged under the ground surface. The compression pipe and the wind wheel are arranged on the ground surface. The wind wheel can convert the wind energy in different directions into power to rotate the magnetic compression blades in the compression pipe. The air with moisture is compressed into the cooling pipe and condensed to liquid water by utilizing the temperature difference between the ground surface and the underground. The liquid water is stored in the water collecting tank. The air whose moisture has been removed is discharged through the pressure relief pipe on the water collecting tank. An air output of the pressure relief pipe is blocked by the plug so that the pressure in the water collecting tank rises. The water in the water collecting tank is lifted to the ground surface by the outlet pipe for people's use. The rotation of the magnetic compression blades make the power generating coil to generate electric energy which is supplied to the ultraviolet disinfecting lamp for disinfecting the condensed water. The wind-driven air-compressed energy-saving collecting and filtering device for field fresh water has reasonable and simple structure, convenient to use, low cost, convenient to install, energy saving and environment friendly which effectively solve the problem of lack of fresh water in specific areas such as deserts and islands.

The exemplary embodiments of the present invention are thus fully described. Although the description referred to particular embodiments; it will be clear to one skilled in the art that the present invention may be practiced with variations of these specific details. Hence this invention should not be construed as limited to the embodiments set forth herein.

What is claimed is:

1. A wind-driven air-compressed energy-saving collecting and filtering device for field fresh water, comprising: a water collecting tank 1, a cooling pipe 2, a compression pipe 4 and a wind wheel 5, wherein the water collecting tank 1 and the cooling pipe 2 are arranged under the ground surface, and the compression pipe 4 and the wind wheel 5 are arranged on the ground surface; the water collecting tank 1 is provided with a pressure relief pipe 11 communicated with the ground surface and the inner cavity of the water collecting tank 1; an outlet pipe 12 is provided in the inner cavity of the pressure relief pipe 11, and a plug 15 is arranged on the port at one end of the pressure relief pipe 11 located at the ground surface,
wherein the cooling pipe 2 is a transparent pipe body vertically disposed above the water collecting tank 1; the lower end of the cooling pipe 2 and the water collecting tank 1 are fixed to each other, and the inner cavity of the cooling pipe 2 communicates with the inner cavity of the water collecting tank 1; the outer side of the cooling pipe 2 is provided with an ultraviolet sterilizer 21, and the inner cavity of the cooling pipe 2 is provided with a fin condenser 22,
wherein the ultraviolet sterilizer 21 includes a first annular housing 211; the inner cavity of the first annular housing 211 is provided with a battery 212; an ultraviolet disinfecting lamp 213 is disposed adjacent to the outer wall of the cooling pipe 2 in the inner cavity of the first annular housing 211,
wherein the fin condenser 22 includes a vertically disposed support shaft 221 and fins 222 radially fixedly disposed on the support shaft; the support shaft 221 is fixedly connected to the inner wall of the cooling pipe 2; the fins 222 abuts against the inner wall of the cooling pipe 2,
wherein the compression pipe 4 is disposed above the cooling pipe 2, and the lower end of the compression pipe 4 is sleeved and fixedly connected to the upper end of the cooling pipe 2; the compression pipe 4 has a tapered inner cavity, and the upper end of the compression pipe 4 is threadedly connected to an end cover 45 made of a mesh plate, a second annular housing 41, and a power generating coil 411 disposed in the inner cavity of the second annular housing 41,
wherein the end cover 45 is provided with a commutator 47; the inner cavity of the compression pipe 4 is provided with a first rotating shaft 49, magnetic compression blades 44 fixedly connected to the first rotating shaft 49, and a limiting mesh plate 40; two ends of the first rotating shaft 49 are respectively connected to the commutator 47 and the limiting mesh plate 40,
wherein the commutator 47 includes a housing 471, a first ratchet 472, a plurality of transmission gears 473, and a second ratchet 474; the first rotating shaft 49 and the second rotating shaft 48 protrude symmetrically into the inner cavity of the housing 471; the first ratchet 472 and the second ratchet 474 are drivingly connected to the second rotating shaft 48 by the transmission gears 473; the first ratchet 472 is drivingly connected to the first rotating shaft 49 by the third rotating shaft 478 and the transmission gears 473; the second ratchet 474 is connected to the first rotating shaft 473 sequentially through the transmission gears 49 and the fourth rotating shaft 477,
wherein the first ratchet 472 and the second ratchet 474 respectively include a disc 4741, a magnetic ratchet 4743 hinged along the circumference of the disc 4741, and a receiving groove 4742 for receiving the ratchet 4743,
wherein the wind wheel 5 includes a bracket 51 fixedly connected to the second rotating shaft 48 and Y-shaped blades 52 disposed on the bracket 51.

2. The wind-driven air-compressed energy-saving collecting and filtering device for field fresh water of claim 1, wherein the outer surface of the water collecting tank 1 is provided with a plurality of heat conducting plates 13, and the heat conducting plates 13 are provided with a plurality of heat conducting rods 14.

3. The wind-driven air-compressed energy-saving collecting and filtering device for field fresh water of claim 1, wherein the fin 222 in a spiral shape is fixedly connected to the support shaft 221, and a plurality of through holes are arranged on the fin 222.

4. The wind-driven air-compressed energy-saving collecting and filtering device for field fresh water of claim 1, wherein the outer surface of the end cover 45 is provided with a filter net 46.

5. The wind-driven air-compressed energy-saving collecting and filtering device for field fresh water of claim 1, wherein the upper end of the compression pipe 4 is provided with a sunshade mechanism 42, and the sunshade mechanism 42 includes a support rod 421 connected to the outer wall of the compression pipe 4 by a magnetic ball joint: the support rod 421 is provided with an elastic shade cloth 422.

6. The wind-driven air-compressed energy-saving collecting and filtering device for field fresh water of claim 1, wherein the lower end of the compression pipe 4 is provided with a stabilizing plate 43 for preventing the compression pipe 4 and the wind wheel 5 from tipping over; the middle portion of the stabilizing plate 43 is sleeved and fixed with the compression pipe 4.

7. The wind-driven air-compressed energy-saving collecting and filtering device for field fresh water of claim 1, the disc 4741 is made of a non-magnetizable material; the magnetic ratchet 4743 abuts against the inner wall of the receiving groove 4742 when the magnetic ratchet 4743 is deployed; when the magnetic ratchet 4743 needs to be taken away, it contracts and is accommodated into the receiving groove 4742.

8. The wind-driven air-compressed energy-saving collecting and filtering device for field fresh water of claim 1, wherein the power generating coil 411 is electrically connected to the battery 212.

9. The wind-driven air-compressed energy-saving collecting and filtering device for field fresh water of claim 1, wherein the bracket 51 includes two support plates 511 and a connecting shaft 512 for connecting the two support plates 511; the Y-shaped blades 52 are radially fixed on the connecting shaft 512.
